(19) United States
(12) Patent Application Publication
(10) Pub. No.: US 2012/0233642 A1
(43) Pub. Date: Sep. 13, 2012

(54) Musical Content Associated with Video Content

(75) Inventors: Kathy Piatt, Cedar Park, TX (US); Anita Hogans Simpson, Decatur, GA (US)

(73) Assignee: AT&T Intellectual Property I, L.P., Atlanta, GA (US)

(21) Appl. No.: 13/045,928

(22) Filed: Mar. 11, 2011

(51) Int. Cl. H04N 5/445

(52) U.S. Cl. 725/60

(57) ABSTRACT

A particular method includes presenting video content at a display and receiving a request to purchase playback rights to musical content associated with the video content. The method includes, in response to the request, determining whether a video content provider associated with the video content permits presentation of a menu at the display while the video content is being presented. The method includes, in response to determining that the video content provider permits the presentation of the menu at the display while the video content is being presented, presenting the menu concurrently with the video content. The method further includes, in response to determining that the video content provider prohibits the presentation of the menu at the display while the video content is being presented, inhibiting presentation of the menu at the display while the video content is being presented.

### FIELD OF THE DISCLOSURE

The present disclosure is generally related to accessing musical content associated with video content.

### BACKGROUND

A viewer watching video content, such as a movie, may have interest in obtaining playback rights to musical content that accompanies a portion of the movie. Obtaining the playback rights may be a complicated process. For example, the viewer may be unfamiliar with a title of the musical content. Accordingly, the viewer may perform a search (e.g., using a computer and a search engine) to determine the title of the musical content of interest. The viewer may separately initiate a transaction to obtain the playback rights to the musical content of interest.

### BRIEF DESCRIPTION OF THE DRAWINGS

FIG. 1 is a block diagram illustrating a particular embodiment of a system to enable purchase of playback rights to musical content associated with video content;

FIG. 2 is a flow diagram illustrating a particular embodiment of a method of providing playback rights to musical content associated with video content;

FIG. 3 is an illustration of a particular embodiment of a menu of selectable musical content associated with video content;

FIG. 4 is an illustration of a particular embodiment of a menu enabling purchase of playback rights to musical content associated with video content; and

FIG. 5 is block diagram of a general computer system operable to support embodiments of computer-implemented methods, computer program products, and system components as illustrated in FIGS. 1-4.

### DETAILED DESCRIPTION

A viewer watching video content may have interest in purchasing playback rights to musical content accompanying the video content. In this context, playback rights refers to an ability to listen to the musical content at the viewer's discretion. Examples of purchasing playback rights include downloading or streaming data representative of the musical content, or otherwise enabling access to the musical content by a device controlled by the viewer. To purchase the playback rights, the viewer may identify the musical content of interest, determine whether the playback rights are available, and initiate a transaction to purchase the playback rights. Identifying the musical content and purchasing the playback rights, when available, may be done concurrently with viewing the video content. For example, a menu identifying musical content associated with the video content may be generated when the viewer indicates a desire to purchase the playback rights. Since displaying the menu concurrently with the video content may be disruptive, a video content provider, such as a distributor of the video content, may permit or prohibit concurrent display of the menu while the video content is being presented. Alternatively, the viewer may prefer to have the menu displayed concurrently with video content presentation, or may prefer that the menu be displayed after the video content presentation is complete, or may prefer that the menu be displayed separate from the video content.

In a particular embodiment, a method includes presenting video content at a display and receiving a request to purchase playback rights to musical content associated with the video content. The method includes, in response to the request, determining whether a video content provider associated with the video content permits presentation of a menu at the display while the video content is being presented. The method includes, in response to determining that the video content provider permits the presentation of the menu at the display while the video content is being presented, presenting the menu concurrently with the video content. The method further includes, in response to determining that the video content provider prohibits the presentation of the menu at the display while the video content is being presented, inhibiting presentation of the menu at the display while the video content is being presented.

In a particular embodiment, a server includes a processor configured to receive a request from a viewer device. The request is related to purchase of playback rights to particular musical content associated with the video content. The request may be received during presentation of video content by the viewer device. The server is configured to determine, in response to the request, whether a video content provider associated with the video content permits display of a menu at the viewer device currently with the video content that is being presented. The menu can include selectable titles of musical content associated with the video content. The server is configured to provide the menu to be displayed at the viewer device concurrently with the video content in response to the video content provider permitting the display of the menu while the video content is being presented. The server is configured to inhibit presentation of the menu while the video content is being presented in response to the video content provider not permitting the display of the menu while the video content is being presented.

In a particular embodiment, a set top box device includes a display interface and a processor coupled to the display interface. The processor is configured to receive a request to purchase playback rights to musical content that is associated with video content being presented at a display coupled to the display interface. The set-top box device is configured to send a query to a server, in response to the request, to determine whether a video content provider of the video content permits presentation of a menu associated with the musical content concurrently with the video content. The set-top box device may (e.g., in response to instructions received from the server) present the menu at the display while the video content is being presented at the display in response to a first indication from the server that the video content provider permits presentation of the menu concurrently with the video content. The set-top box device may (e.g., in response to instructions received from the server) inhibit presentation of the menu until a time when the video content is not being presented in response to receipt of a second indication from the server that the video content provider prohibits presentation of the menu concurrently with the video content.

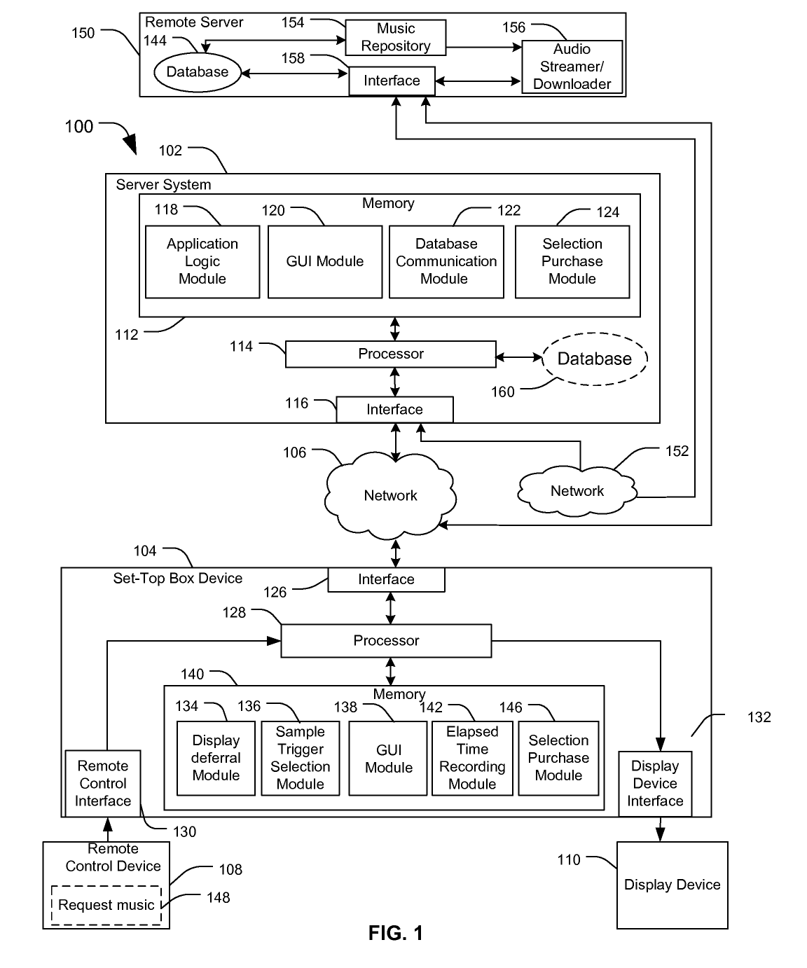

FIG. 1 is a block diagram illustrating a particular embodiment of a system 100 to enable purchase of playback rights to musical content associated with video content. The system 100 may include a server system 102 that may provide video content to one or more set-top box devices, such as a set-top box device 104, via a network 106, such as an internet network, a cable network, a fiber optic network, a satellite network, another type of network, or any combination thereof. The server system 102 may be configured to couple to a remote server 150 through an interface 158 of the remote server 150 via, e.g. a network 152, such as an internet network, a cable network, a fiber optic network, a satellite network, another type of network, or any combination thereof. The set-top box device 104 may display the video content received from the server system 102 at a display device, such as display device 110.

The server system 102 includes a memory 112, a processor 114, an interface 116, and optionally, an internal database 160. The interface 116 enables communication between the server system 102 and one or more devices coupled to the network 106. The memory 112 of the server system 102 may include various modules that are executable to implement functions of the server system 102, such as an application logic module 118, a graphical user interface (GUI) module 120, a database communication module 122, and a selection purchase module 124.

The application logic module 118 may include processor executable instructions that when executed by the processor 114, enable the processor 114 to inhibit display of a menu (e.g., suppress the display of the menu) on a display device. For example, the application logic module 118 may cause the display of the menu on the display device to be deferred until a time when the video content is not being presented. The GUI module 120 may include processor executable instructions that when executed by the processor 114, enable the processor 114 to formulate a GUI to be displayed on a display device, such as the display device 110. For example, the GUI may include selectable options. The database communication module 122 may include processor executable instructions that when executed by the processor 114, enable the processor 114 to query a database, such as database 144 of the remote server 150 via the network 152 (or another database such as the internal database 160 of the server system 102), for information pertaining to musical content associated with the video content being presented. (In an example, the server system 102 may be operated by a party such as a video content provider, and the remote server 150 including the database 144 may be operated by a different party such as a music content provider.) For example, the database communication module 122 may generate a query based on a viewer-initiated request and may provide results of the query to the GUI module 120 to generate a menu of the selectable options within the GUI. The selection purchase module 124 may include processor executable instructions that when executed by the processor 114, cause the processor 114 to enable a purchase of playback rights to selected musical content that is associated with the video content. For example, the selection purchase module 124 may provide information to the GUI module 120 to enable initiation of a transaction to purchase playback rights to musical content associated with the video content and may communicate with a secure transaction server to implement the purchase.

The set-top box device 104 may include an interface 126 that enables communication via the network 106, a processor 128 that is coupled to the interface 126, and a memory 140 that is coupled to the processor 128. The set-top box device 104 may also include a remote control interface 130 that enables communication with a remote control device 108 and a display device interface 132 that enables communication with the display device 110.

The memory 140 of the set-top box device 104 may include various modules that are executable to implement functions of the set-top box device 104 such as a display deferral module 134, a sample trigger selection module 136, a graphical user interface (GUI) module 138, an elapsed time recording module 142, and a selection purchase module 146. The display deferral module 134 may include processor executable instructions that when executed by the processor 128, enable the processor 114 to inhibit display of a menu (e.g., suppress the display of the menu) at a display device. For example the display deferral module 134 may cause the display of the menu on the display device 110 to be deferred until a time when the video content is not being presented. The sample trigger selection module 136 may include processor executable instructions that when executed by the processor 128, enable the processor 128 to provide one or more sound samples to a viewer. For example, the sound sample may correspond to a musical content selection associated with the video content being presented at the display device 110. The GUI module 138 includes processor executable instructions that when executed by the processor 128, enable the processor 128 to formulate a GUI to be displayed at the display device 110. For example, the GUI may include a menu of selectable options associated with the musical content.

The elapsed time recording module 142 may include processor executable instructions that when executed by the processor 128, enable the processor 128 to generate a data record indicating an elapsed time of the video content when a request is received from a user. For example, the data record may be generated when an indication is received from an input device (such as the remote control device 108). The indication may be generated by the viewer at a particular time when the viewer hears particular musical content of interest to the viewer. To illustrate, when the viewer hears the particular musical content of interest to the viewer, the viewer may activate a request music button 148. In response to activation of the request music button 148, the elapsed time recording module 142 may generate the data record identifying the particular time when the viewer hears the particular musical content. The particular time may be correlated with the elapsed time of the video content, e.g., by the processor 114 executing instructions in the elapsed time recording module 142.

In another illustration, by activating the request music button 148 each time the viewer hears musical content of interest to the viewer, a list of musical content items of interest that are associated with the video content may be generated and may be displayed, e.g., at a time when the video content is not being presented. The viewer may edit the list and proceed to purchase playback rights to the musical content items in the edited list. In another illustration, the server system 102 may include event trigger logic that is executable to detect when musical content is being played during playback of video content. The event trigger logic may cause a pop-up selectable option associated with a musical content item to be displayed during the presentation of the video content. By selecting the pop-up selectable option, the viewer can indicate interest in purchasing the musical content item.

The selection purchase module 146 may include processor executable instructions that when executed by the processor 128, enable the processor 128 to facilitate a purchase of playback rights to selected musical content that is associated with the video content. For example, the selection purchase module 146 may provide information to the GUI module 138 to enable initiation of a transaction to purchase playback rights to the musical content accompanying the video content. The selection purchase module 146 may also communicate with a secure transaction server to implement the purchase (e.g., to authorize transfer of funds or charges to an account associated with the viewer, to download or access data representative of the musical content, etc.).

In operation, the server system 102 may provide video content to the set-top box device 104 via the network 106 to be displayed at the display device 110. In a particular example, the network 106 is an internet protocol television network and the video content may be provided via internet protocol television communications.

When the musical content is of interest to a viewer, the viewer may indicate interest in the musical content. For example, the viewer may generate a request indicating interest in the musical content (e.g., by selecting the request music button 148 on the remote control device 108). To illustrate, the request may indicate interest in purchasing playback rights to the musical content. In a particular embodiment, musical content may be included in an audio portion of the video content. The server system 102 may receive the request to purchase playback rights to musical content associated with the video content from the set-top box device 104 via the network 106. In a particular example, in response to receipt of the request, the server system 102 may provide a viewer-detectable indicator to the set-top box 104 to be displayed at the display device 110. The viewer-detectable indicator may indicate that the request has been received at the server system 102.

In response to receipt of the request at the server system 102, the processor 114 may determine whether a content provider associated with the video content prohibits display of a menu at the display device 110 while the video content is being presented at the display device. For example, the server system 102 may store information in the memory 112 of the server system 102 that indicates that the content provider prohibits display of the menu at the display device 110 while the video content is being presented at the display device 110. In another example, the server system 102 may send a query to the content provider to determine whether the content provider prohibits display of the menu at the display device 110 while the video content is being presented at the display device 110. The content provider may include an entity that produces or distributes the video content, such as a media network (e.g., ESPN, CBS). Alternatively, the content provider may include an entity that owns rights to or is licensed to control distribution of the video content.

The menu to be displayed may include one or more selectable options that enable the viewer to indicate particular musical content for which the viewer wants to obtain the playback rights. The server system 102 may receive information indicating that display of the menu is prohibited while the video content is being displayed. In another alternative, the server system 102 may receive information indicating that the viewer does not wish to view the menu while watching the video content. For example, the set-top box device 104 or the server system 102 may store viewer preferences that indicate that the viewer does not wish to view the menu concurrently with the video content. Alternatively, the viewer may indicate that the viewer does not wish to view the menu concurrently with the video content when the viewer indicates interest in the musical content.

When the concurrent display of the menu and the video content is prohibited by the content provider or is indicated to be undesirable by the viewer, the processor 114 can execute instructions in the application logic module 118 to inhibit display of the menu concurrently with presentation of the video content by suppressing the display of the menu. For example, a viewer-detectable indicator may be provided to the set-top box 104 to indicate that the menu will be displayed after the video content presentation is concluded. In a particular example, the menu may be provided by the server system 102 to the set-top box device 104 at the conclusion of presentation of the video content (e.g., after a particular program of the video content ends or is terminated by the viewer). In another particular example, the menu may be displayed at a viewer-selected time, such as by viewer selection of a control input, such as a soft button that may be displayed at the conclusion of the video content presentation.

In response to receipt of the request by the server system 102, the processor 114 may execute instructions in the database communication module 122 to initiate a query to the database 144 in order to obtain information pertaining to the musical content associated with the video content. In a particular example, the database 144 may include a list of video content items, such as movies, and a corresponding list identifying musical content associated with each video content item. For example, the list identifying musical content may include one or more of the following: titles of musical compositions, identifications of arrangements, names of composers of musical compositions, names of arrangers of musical content items, musicians that performed in a musical content selection, other data related to the musical content items, or any combination thereof. The database 144 may include a publicly available search engine database, such as the International Movie Database or another searchable index that relates video content with related musical content.

In a particular example, each video content item in the database 144 may be cataloged along with an indication of when particular musical content is presented in the video content. For example, the video content may be divided into time intervals that are indexed from commencement of the video content. A particular one or more of the time intervals may correspond to the particular musical content. For example, in a particular movie, an opening song may play from 10 sec-50 sec (0:10-0:50) of video content presentation of the movie. A second piece of musical content may commence at two minutes from the start of the movie and may play for 30 sec (2:00-2:30). The database 144 may store an identifier, e.g., a title or other identifier of each of the musical content items associated with the movie and time interval information associated with each of the musical content items associated with the movie.

The server system 102 may receive a list of titles associated with the musical content items associated with the video content from the database 144. The processor 114 may execute processor instructions within the GUI module 120 to generate the menu and to populate the menu with selectable options, such as the titles that have been received from the database 144. The server system 102 may communicate the menu to the set-top box device 104 to be displayed at the display device 110.

In another particular embodiment, the server system 102 receives from the set-top box device 104 an indication of elapsed time of the video content when the musical content of interest is heard by the viewer (e.g., when the viewer indicates interest in the musical content). Alternatively, the processor 114 of the server system 102 may determine information (e.g., elapsed time) that correlates a time when the request is generated (e.g., by the viewer) to a portion of the video content. The server system 102 may provide (e.g., to the database 144) an indication of the elapsed time of the video content to enable identification of the musical content. In a particular illustrative example, the query by the server system 102 to the database 144 may include the indication of the elapsed time. In response to the query, the server system 102 may receive from the database 144 a particular title or set of titles of musical content that is presented in the video content at or near a time indicated by the elapsed time. When only one title is returned, the title can be included as a single selectable option in the menu sent to the set-top box device 104 to be displayed at the display device 110.

After providing the menu to the set-top box device 104, the server system 102 may receive from the set-top box device 104 an indication of a particular musical content item of interest that is selected from the menu by the viewer. In response to receipt of the indication of the particular musical content item, the server system 102 may execute processor instructions in the selection purchase module 146 to initiate a transaction between the viewer and a licenser of the selected musical content or other entity associated with the selected musical content (when the playback rights are available) to purchase playback rights to the selected musical content. Upon completion of the transaction, the server system 102 may send an indication to the set-top box device 104 that the playback rights have been purchased. The server system 102 may issue a request to a music repository 154 within the remote server 150 to provide the selected musical content via an audio streamer/downloader 156 to, e.g., the set-top box device 104 via the network 106 or to another destination device (not shown).

In another particular embodiment, the set-top box device 104 may receive from the viewer a request to purchase playback rights to a musical content selection associated with the video content that is being presented. In response to receipt of the request at the set-top box device 104, the processor 128 may determine whether a content provider associated with the video content prohibits display of a menu at the display device 110 while the video content is being presented at the display device 110. For example, the set-top box device 104 may provide channel information associated with a currently tuned channel to the application logic module 118 of the server system 102. The application logic module 118 may use the channel information to instruct the set-top box device 104 to display the menu concurrently with the video content being presented via the currently tuned channel. Alternatively, the application logic module 118 may instruct the set-top box device 104 to display a selectable indicator enabling the viewer to request display of the menu at a viewer selected time. For example, the set-top box device 104 may store information in the memory 140 of the set-top box device 104 that indicates that the content provider prohibits display of the menu at the display device 110 while the video content is being presented at the display device 110. In another example, the set-top box device 104 may send a query to the content provider to determine whether the content provider prohibits display of the menu at the display device 110 while the video content is being presented at the display device 110.

The content provider may include an entity that produces or distributes the video content, such as a media network (e.g., ESPN, CBS). Alternatively, the content provider may include an entity that owns rights to or is licensed to control distribution of the video content. In a particular embodiment, the server system 102, the database 144, the video content provider, and the licenser may be part of the same entity. In another particular embodiment, the server system 102, the database 144, the video content provider, and the licenser may be a part of two or more different entities.

The menu to be displayed may include one or more selectable options that enable the viewer to indicate particular musical content for which the viewer wants to obtain the playback rights. The set-top box device 104 may receive information indicating that display of the menu is prohibited while the video content is being displayed. In another alternative, set-top box device 104 may receive information indicating that the viewer does not wish to view the menu while watching the video content. For example, the set-top box device 104 or the server system 102 may store viewer preferences indicating that the viewer does not wish to view the menu while watching the video content. Alternatively, the viewer may indicate that the viewer does not wish to view the menu while watching the video content when the viewer indicates interest in the musical content.

The set-top box device 104 may receive from the server system 102 an indication of whether the content provider prohibits concurrent display of the menu and the video content. For example, the server system 102 may return a first indication that the video content provider permits presentation of the menu concurrently with the video content. In another example, the server system 102 may return a second indication that the video content provider prohibits presentation of the menu concurrently with the video content. When the content provider prohibits concurrent display of the menu and the video content, the processor 128, executing processor instructions from the display deferral module 134, may inhibit presentation of the menu while the video content is being displayed. For example, the set-top box device 104 may receive information to generate the menu and may suppress display of the menu until after the video content has been presented. In another example, the viewer may indicate that the viewer prefers to view the menu after the conclusion of the video content presentation. To illustrate, the viewer may indicate a preference to defer display of the menu until after the conclusion of the video content presentation when the viewer requests purchase of playback rights. Alternatively, the memory 140 or the server system 102 may store user preferences (e.g., in a table of user preferences) including an indication that the viewer prefers to delay display of the menu until after the conclusion of the video content presentation. The processor 128, executing processor instructions in the display deferral module 134, may inhibit presentation of the menu while the video content is being displayed in response to the viewer's expressed preference.

In a particular example, the set-top box device 104 can provide an indication that the menu will not be displayed while the video content is being displayed. For example, a visual indicator may be displayed on the display device 110 indicating deferral of the display of the menu until presentation of the video content is complete. Alternatively, an audible cue may be presented indicating deferral of the display of the menu until the presentation of the video content is complete. In a particular illustrative example, the set-top box device 104 may present a selectable option at the display device 110 after the video content is finished presenting and the viewer can view the menu by activating the selectable option (e.g., using the remote control device 108).

In a particular illustrative embodiment, the set-top box device 104 may send to the server system 102 a request for information pertaining to musical content associated with the video content being presented. In response to the request, the set-top box device 104 may receive from the server system 102 a list identifying musical content items associated with the video content being presented. Alternatively, the information received by the set-top box device 104 from the server system 102 can indicate the unavailability of the playback rights to one or more of the musical content items associated with the particular video content. For example, playback rights to a particular musical content item may be unavailable when a viewer account is not permitted to access the musical content item, such as when the viewer account is not enabled for this function. In another example, the playback rights may not be available to purchase when one or more parties associated with the musical content (e.g., a composer or performer) is unwilling to license the playback rights. In another example, playback rights to a particular musical content item may be unavailable in response to a viewer device that does not accept a particular format in which the musical content item is available. In another example, playback rights to a particular musical content item may be unavailable due to legal constraints such as international trade considerations, copyright restrictions, pending copyright disputes, or other legal considerations.

The processor 128 may execute instructions from the graphical user interface (GUI) module 138 to formulate a menu for display at the display device 110. The menu may include selectable options, where each selectable option corresponds to one of the musical content items associated with the video content presented. The viewer may indicate a selection of one of the selectable options corresponding to the musical content item of interest to the set-top box device 104 using the remote control device 108.

The menu may also include a sample trigger selectable option for one or more of the musical content items. Selection by the viewer of a sample trigger selectable option may trigger playback of a musical sample of a corresponding musical content item. By selecting a sample trigger selectable option, the viewer can listen to the sample to confirm that the corresponding musical content item is of interest (e.g., is the musical content for which the viewer requests playback rights) prior to purchase of associated playback rights. The processor 128 may execute instructions in the sample trigger selection module 136 to cause the selected sample to be played at the display device 110.

In another illustrative embodiment, the request initiated by the viewer may include information identifying a time when the viewer hears the musical content of interest. For example, the request may indicate an elapsed time of the video content when the musical content of interest is played. The set-top box device 104 may contact the server system 102, which may query the database 144 using information indicating the elapsed time. For example, the processor 114 of the server system 102 may determine information (such as the elapsed time) that correlates a time when the request is generated to a portion of the video content. In a particular example, the elapsed time is associated with a particular musical content item, and the database 144 may identify the particular musical content item and return a single identifier of the particular musical content item to the server system 102. The server system 102 may send the single identifier to the set-top box 104. The menu generated may include a single selectable option that corresponds to the elapsed time provided by the viewer. The menu may also include a sample trigger selectable option that the viewer can select to confirm that the musical content identified by the database 144 corresponds to the musical content of interest to the viewer.

In another particular example, the request is sent from the set-top box device 104 to the server system 102 but elapsed time information may not be sent to the database 144. The database 144 may return a plurality of identifiers of the musical content items associated with the video content to the set-top box 104. The menu generated may include a corresponding selectable option associated with each identifier of the musical content items returned from the database 144.

The set-top box device 104 may receive from the viewer a selection of one of the selectable options to purchase playback rights of associated musical content. In response, the processor 128 may execute instructions from the selection purchase module 146 to purchase the playback rights to the musical content item or items of interest. Purchasing the playback rights can include a financial transaction involving the viewer. In a particular illustrative example, the viewer may be presented with several payment options. For example, a cost for obtaining the playback rights may be charged by a provider of the video content, a licenser of the musical content, an intermediary agent, or a combination thereof. To illustrate, the video content may be provided by a satellite television service, internet protocol television service, cable service, or another video content supplier. The playback rights to the musical content may be billed by the video content provider. Alternatively, the playback rights may be billed by a musical content provider or a licenser of the musical content, such as American Society of Composers, Authors, and Publishers (ASCAP), Broadcast Music Inc. (BMI), Society of European Stage Authors and Composers (SESAC), or another licenser or agent of the licenser, such as Harry Fox Agency, Inc. Alternatively, the musical content provider or the licenser of the musical content may be linked to a financial clearing house, such as PayPal, to facilitate the transaction. Alternatively, the video content provider may send information to the music content provider to execute the financial transaction at a server associated with the musical content provider.

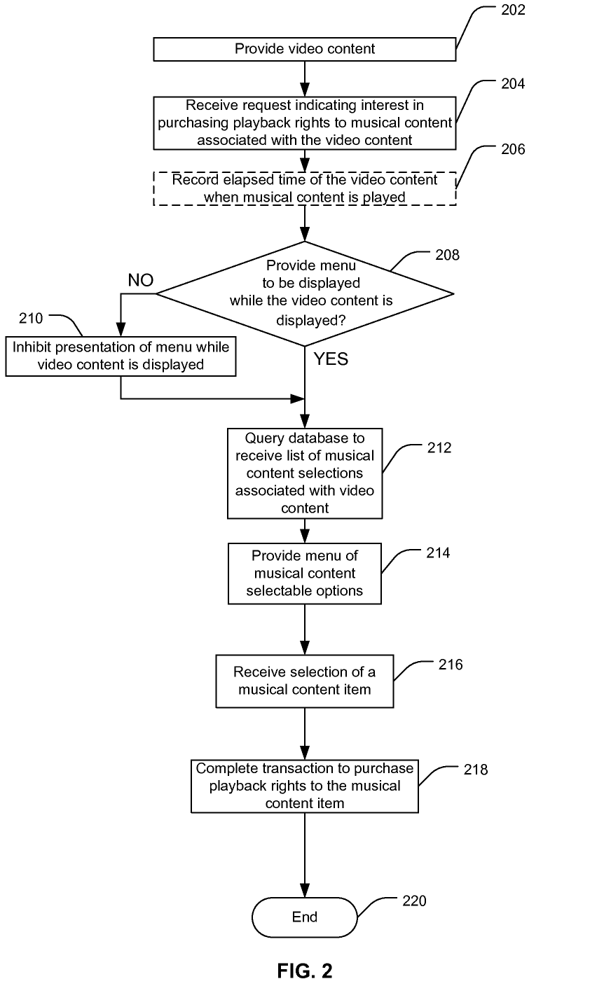

FIG. 2 is a flow diagram illustrating a particular embodiment of a method of providing playback rights to musical content associated with video content. At 202, video content is provided. For example, the video content may be provided by a server system to a set-top box device to be displayed at a display device (such as the display device 110). Alternatively, or in addition, the video content may be provided by the set-top box to the display device. Advancing to 204, a request is received. The request may be initiated by a viewer at the set-top box device. The request may indicate that the viewer is interested in purchasing playback rights to musical content associated with the video content. For example, the request may be received at the set-top box device 104 from the remote control device 108. In another example, the request may be received by the server system 102 from the set-top box 104.

In a particular embodiment, optionally an elapsed time of the video content when the musical content of interest is played may be recorded, at 206. For example, the viewer may select a selectable option (e.g., by activating the request music button 148 on the remote control device 108) while the musical content of interest is being played. The set-top box or the server system may generate a record indicating the elapsed time of the video content when the selectable option is selected.

Proceeding to 208, a determination is made whether the menu and the video content are to be displayed concurrently. For example, a video content provider may be queried to determine whether concurrent display of the menu and the video content is prohibited by the video content provider. Alternatively, the server system or the set-top box may store information (e.g., in a memory) that indicates whether concurrent display of the menu and the video content is prohibited by the video content provider. In another example, the video content provider may include information indicating whether concurrent display of the menu and the video content is allowed in metadata associated with the video content (e.g., in an electronic program guide). In another example, the viewer may request that the menu and the video content not be displayed concurrently. When the video content provider prohibits concurrent display of the menu and the video content, or when the viewer indicates that the menu is not to be concurrently displayed with the video content, the menu may be inhibited from being displayed while the video content is displayed, at 210.

Proceeding to 212, a database is queried to receive a list of musical content items associated with the video content. For example, the musical content may form a portion of an audio track of the video content. In a particular example, when the elapsed time of the video content (e.g., at the time that the request is received) accompanies the request, the database may identify a single musical content item that is associated with the video content at the elapsed time. In another particular example, the database 144 may identify a plurality of musical content items that are associated with the video content.

The menu including one or more selectable options may be provided for display at the display device, at 214. The menu may include selectable options corresponding to the musical content items identified by the database 144 as associated with the video content. For example, the menu may be provided by the server system 102 and may be displayed at the display device 110. Alternatively, information may be provided to the set-top box 104 from the server system 102 and the menu may be provided by the GUI module 138 to be displayed at the display device 110.

In a particular example, the database may return an indication that playback rights of one or more musical content items associated with the video content are not available for purchase to the viewer. In this example, the menu may indicate that those particular musical content selections are unavailable. To illustrate, unavailability of playback rights to a particular musical content item may be indicated by having the corresponding selectable option grayed out in the menu. In another illustration, unavailability of playback rights to a particular musical content item may be indicated by omitting the corresponding selectable option from the menu.

In a particular embodiment, one or more musical content selectable options in the menu may be accompanied by a sample trigger selectable option that enables the viewer to listen to a sample of a particular musical content item prior to purchasing the corresponding playback rights.

An indication of selection of a musical content item may be received, at 216. A transaction may be completed to purchase playback rights to the selected musical content item, at 218. The method ends at 220.

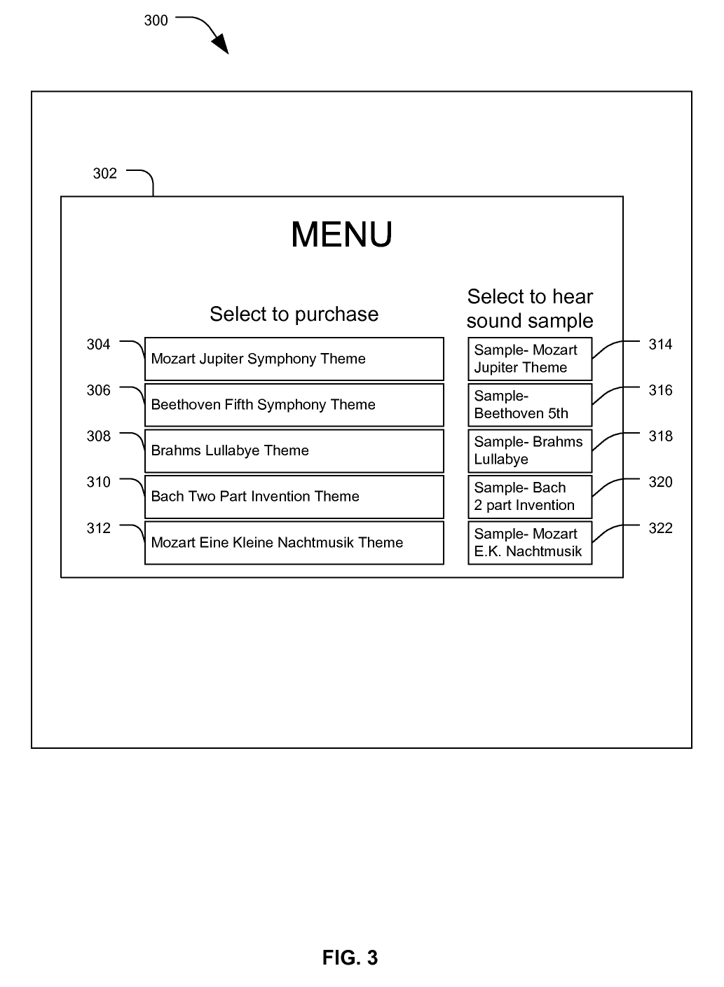

FIG. 3 is an illustration of a particular embodiment of a menu of selectable options corresponding to musical content associated with video content displayed at a display device, such as the display device 110. An interactive screen 300 may include the menu 302 of selectable options. In a particular embodiment, the menu 302 may be displayed at the display device concurrently with a presentation of video content. In another particular embodiment, the menu 302 may be prevented from being concurrently displayed with the video content. Accordingly, the menu 302 may be displayed when the video content is not being displayed, e.g., after the presentation of the video content is completed. The menu 302 may enable a viewer to confirm a selection of the musical content for which purchase of playback rights is requested.

The menu 302 may include selectable options 304, 306, 308, 310, and 312. Each of the selectable options 304-312 may be labeled with or may include information associated with a particular musical content item, such as a title. For example, a first selectable option 304 may be associated with a theme from the Mozart Jupiter symphony, a second selectable option 306 may be associated with a theme from the Beethoven 5^{th} Symphony, a third selectable option 308 may be associated with a theme from the Brahms Lullaby, a fourth selectable option 310 may be associated with a theme from a Bach Two Part Invention, and a fifth selectable option 312 may be associated with a theme from Mozart's Eine Kleine Nachtmusik.

The menu 302 may also include selectable options 314, 316, 318, 320, and 322 that enable playback of samples associated with the musical content items. For instance, the first selectable option selection 304 may be associated with a sixth selectable option 314, the second selectable option 306 may be associated with a seventh selectable option 316, the third selectable option 308 may be associated with an eighth selectable option 318, the fourth selectable option 310 may be associated with a ninth selectable option 320, and the fifth selectable option 312 may be associated with a tenth selectable option 322.

In operation, when the menu 302 is displayed, a viewer can select one or more of the selectable options 304, 306, 308, 310, or 312 to initiate a transaction to purchase playback rights to the corresponding musical content. Alternatively or in addition, the viewer can select one or more of the selectable options 314-322 to hear an audio sample of the corresponding musical content. For example, selecting the seventh selectable option 316 may trigger playing of an audio sample of Beethoven's 5^{th} Symphony that corresponds to the second selectable option 306.

In an example, the viewer may watch video content at a display device and may request purchase of playback rights to a particular musical content item accompanying video content that is being presented. Because a content provider prohibits concurrent display of a menu while the video content is being presented or because of a viewer expressed preference, the menu 302 may not be displayed at the display device until the video content presentation is finished. In response to the request initiated by the viewer, the menu 302 may be generated and is displayed at the display device at the conclusion of the video content presentation. The viewer may listen to samples of the musical content by selecting one or more of the selectable options 314-322 before deciding to purchase the playback rights to one or more of the musical content items. The viewer may select one or more of the selectable options 304-312 to purchase the playback rights to the corresponding musical content.

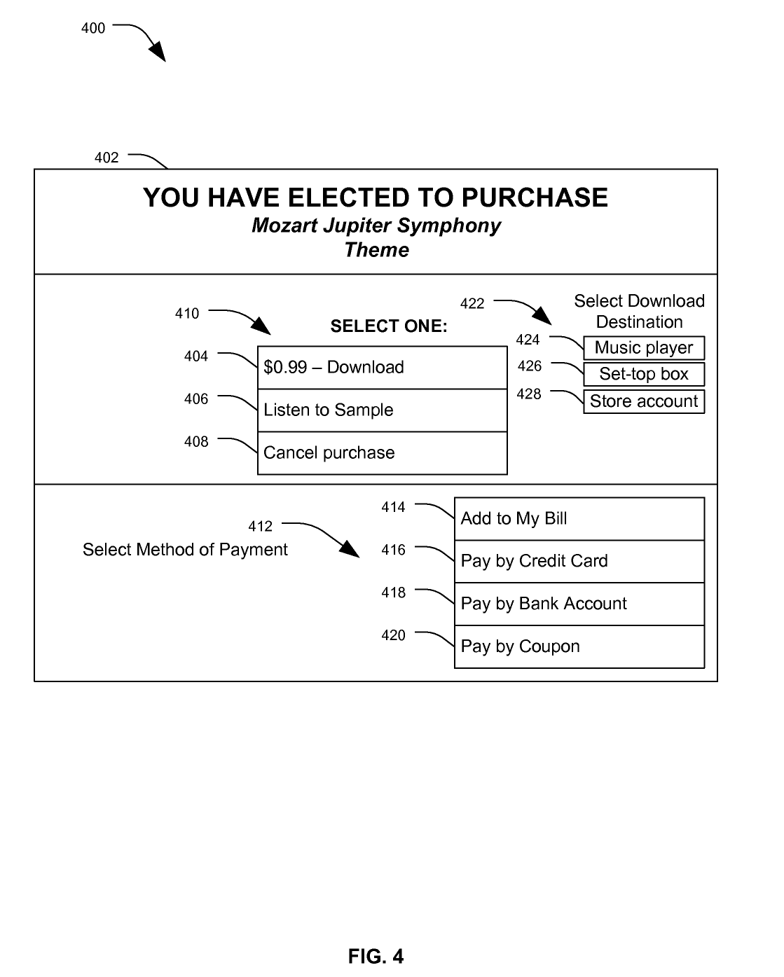

FIG. 4 is an illustration of a particular embodiment of a purchase menu enabling purchase of playback rights to musical content associated with video content. An interactive screen 400 may include the purchase menu 402 enabling purchase of the playback rights to musical content selected by a viewer. The interactive screen 400 may be displayed at a display device (such as the display device 110) subsequent to display of the screen 300 of FIG. 3.

The purchase menu 402 may include selectable options 410 that are associated with purchase of particular musical content that was selected from the menu 302 of FIG. 3. For example, the purchase menu 402 may be presented in response to selection of the first selectable option 304 of FIG. 3, which is associated with the Mozart Jupiter Symphony Theme. Alternatively, when only one musical content item of interest has been identified, the purchase menu 402 may be displayed without the menu 302 having been previously displayed. The selectable options 410 may include a selectable option 404 associated with purchase of or access to the musical content indicated as “Mozart Jupiter Symphony Theme.” The purchase menu 402 may include selectable options 422 enabling the viewer to select a destination of a streaming or download file including the musical content. For example, selection of selectable option 424 results in a download (or streaming) of the musical content to a personal player device, selection of selectable option 426 results in a download (or streaming) of the musical content to the set-top box device 104, and selection of selectable option 428 results in a download (or streaming) of the musical content to a viewer's music store account.

Downloading or streaming music to the set-top box device 104 may be accomplished with a specific audio file format based on the set-top box device type, while downloading the music to a specific music store account may be accomplished with another audio file format. Selection of one of the selectable options 422 may determine the audio file format of the download that is compatible with the destination device. For example, the selectable option 424 may enable a Moving Picture Experts Group (MPEG)-1 or MPEG-2 audio layer 3 file (mp3) file download of an mp3 file including the Mozart Jupiter Symphony Theme to the viewer's personal music player. Alternatively, the selectable options 426 or 428 may be associated with purchase of file in a different audio file format, such as Waveform Audio File Format (WAV), Audio Interchange File Format (AIFF), or another audio file format that includes the Mozart Jupiter Symphony Theme.

The selectable options may also include a selectable option 406 associated with listening to a sample of the Mozart Jupiter Symphony Theme and a selectable option 408 associated with cancellation of the purchase. For example, the viewer may select the selectable option 406 to listen to a sample of the musical content to re-confirm the viewer's decision to purchase playback rights to the Mozart Jupiter Symphony Theme. The viewer may elect to access (e.g., download or stream) a file (e.g., an mp3 file) including data that enables playback of the Mozart Jupiter Symphony Theme by selecting the selectable option 404.

The viewer may also select a method of payment using a method of payment selectable options 412. The method of payment selectable options 412 include a selectable option 414 to charge the purchase to the viewer's bill, a selectable option 416 to pay by credit card, a selectable option 418 to pay by bank account, a selectable option 420 to pay by coupon, other selectable options to pay by other methods, or a combination thereof. The viewer may select the method of payment from the method of payment selectable options 412 to complete purchase of the playback rights and to receive authorization to access the musical content.

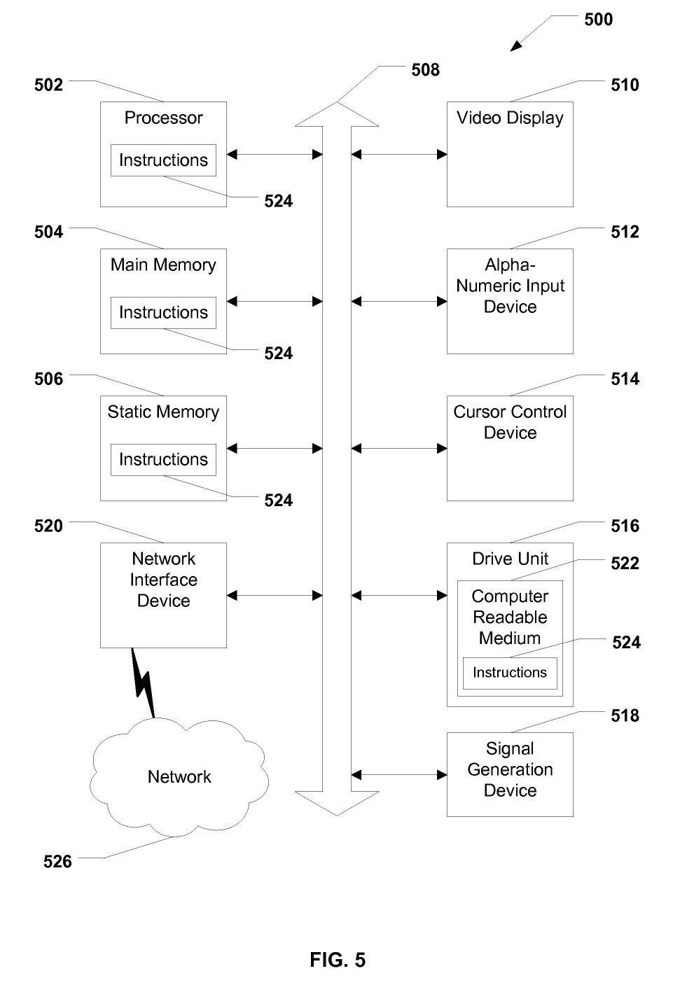

Referring to FIG. 5, an illustrative embodiment of a general computer system is shown and is designated 500. For example, the computer system 500 may include, implement, or be implemented by one or more components of the system 100 of FIG. 1. The computer system 500 includes a set of instructions 524 that can be executed to cause the computer system 500 to perform any one or more of the methods or computer based functions disclosed herein. The computer system 500, or any portion thereof, may operate as a standalone device or may be connected, e.g., using a network, to other computer systems or peripheral devices.

In a networked deployment, the computer system 500 may operate in the capacity of a set-top box device, a personal computing device, a mobile computing device, or some other computing device. The computer system 500 can also be implemented as or incorporated into various devices, such as a personal computer (PC), a tablet PC, a personal digital assistant (PDA), a mobile device, a palmtop computer, a laptop computer, a desktop computer, a communications device, a web appliance, a television or other display device, or any other machine capable of executing a set of instructions (sequential or otherwise) that specify actions to be taken by that machine. In a particular embodiment, the computer system 500 can be implemented using electronic devices that provide voice, video, or data communication. Further, while a single computer system 500 is illustrated, the term “system” shall also be taken to include any collection of systems or sub-systems that individually or jointly execute a set, or multiple sets, of instructions to perform one or more computer functions.

As illustrated in FIG. 5, the computer system 500 may include a processor 502, e.g., a central processing unit (CPU), a graphics-processing unit (GPU), or both. Moreover, the computer system 500 can include a main memory 504 and a static memory 506 that can communicate with each other via a bus 508. As shown, the computer system 500 may further include or be coupled to a video display unit 510, such as a liquid crystal display (LCD), an organic light emitting diode (OLED), a flat panel display, a solid-state display, or a projection display. For example, the video display unit 510 may be the display device 110 of FIG. 1. Additionally, the computer system 500 may include an input device 512, such as a keyboard, a remote control device, and a cursor control device 514, such as a mouse. In a particular embodiment, the cursor control device 514 may be incorporated into a remote control device such as the remote control device 108 of FIG. 1. The computer system 500 can also include a disk drive unit 516, a signal generation device 518, such as a speaker, and a network interface device 520. The network interface device 520 may be coupled to other devices (not shown) via a network 526, such as the network 106 of FIG. 1.

In a particular embodiment, as depicted in FIG. 5, the disk drive unit 516 may include a computer-readable non-transitory medium 522 in which one or more sets of instructions 524, e.g. software, can be embedded. Further, the instructions 524 may embody one or more of the methods or logic as described herein. In a particular embodiment, the instructions 524 may reside completely, or at least partially, within the main memory 504, the static memory 506, and/or within the processor 502 during execution by the computer system 500. The main memory 504 and the processor 502 also may include computer-readable non-transitory media.

In an alternative embodiment, dedicated hardware implementations, such as application specific integrated circuits, programmable logic arrays and other hardware devices, can be constructed to implement one or more of the methods described herein. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by the computer system 500. Further, in an exemplary, non-limited embodiment, implementations can include distributed processing, component/item distributed processing, and parallel processing. Alternatively, virtual computer system processing can be used to implement one or more of the methods or functionality as described herein.

The present disclosure contemplates a computer-readable non-transitory medium that includes instructions 524 so that a device connected to the network 526 can communicate voice, video, or data over the network 526. Further, the instructions 524 may be transmitted or received over the network 526 via the network interface device 520.

While the computer-readable non-transitory medium is shown to be a single medium, the term “computer-readable medium” includes a single medium or multiple media, such as a centralized or distributed database, and/or associated caches and servers that store one or more sets of instructions. The term “computer-readable non-transitory medium” shall also include any tangible medium that is capable of storing a set of instructions for execution by a processor or that cause a computer system to perform any one or more of the methods or operations disclosed herein.

In a particular non-limiting, exemplary embodiment, the computer-readable non-transitory medium can include a solid-state memory such as a memory card or other package that houses one or more non-volatile read-only memories. Further, the computer-readable non-transitory medium can be a random access memory or other volatile re-writable memory. Additionally, the computer-readable non-transitory medium can include a magneto-optical or optical medium, such as a disk or tapes. Accordingly, the disclosure is considered to include any one or more of a computer-readable non-transitory storage medium and successor media, in which data or instructions may be stored.

It should also be noted that software that implements the disclosed methods may optionally be stored on a tangible storage medium, such as: a magnetic medium, such as a disk or tape; a magneto-optical or optical medium, such as a disk; or a solid state medium, such as a memory card or other package that houses one or more read-only (non-volatile) memories, random access memories, or other re-writable (volatile) memories.

Although the present specification describes components and functions that may be implemented in particular embodiments with reference to particular standards and protocols, the disclosure is not limited to such standards and protocols. For example, standards for Internet, other packet switched network transmission (e.g. TCP/IP, UDP/IP, HTML, X10, SIP, TR-069, INSTEON, WEP, Wi-Fi and HTTP) and standards for viewing media content (e.g. MPEG and H.264) represent examples of the state of the art. Such standards are periodically superseded by faster or more efficient equivalents having essentially the same functions. Accordingly, replacement standards and protocols having the same or similar functions as those disclosed herein are considered equivalents thereof.

One or more embodiments of the disclosure may be referred to herein, individually and/or collectively, by the term “invention” merely for convenience and without intending to voluntarily limit the scope of this disclosure to any particular concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above-disclosed subject matter is to be considered illustrative, and not restrictive, and the appended claims are intended to cover all such modifications, enhancements, and other embodiments, which fall within the scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method comprising:
presenting video content at a display;
receiving a request to purchase playback rights to musical content associated with the video content;
in response to the request, determining whether a video content provider associated with the video content permits presentation of a menu at the display while the video content is being presented;
in response to determining that the video content provider permits the presentation of the menu at the display while the video content is being presented, presenting the menu concurrently with the video content; and
in response to determining that the video content provider prohibits the presentation of the menu at the display while the video content is being presented, inhibiting presentation of the menu at the display while the video content is being presented.

2. The method of claim 1, further comprising in response to the video content provider prohibiting the presentation of the menu while the video content is being presented, presenting the menu separately or at a time when the video content is not being presented.

3. The method of claim 1, further comprising determining an elapsed time of the video content when the request is received.

4. The method of claim 3, further comprising providing an indication of the elapsed time of the video content to enable identification of the musical content.

5. The method of claim 1, wherein the menu includes an indication of whether the playback rights to the musical content are available for purchase.

6. The method of claim 5, wherein the menu includes a first interactive screen enabling a viewer to confirm a selection of the musical content for which purchase of the playback rights is requested.

7. The method of claim 6, wherein the menu includes a second interactive screen enabling purchase of the musical content in response to selection of the musical content.

8. A server comprising:
a processor, the processor configured to:
receive a request from a set-top box device during presentation of video content, the request related to purchase of playback rights to particular musical content associated with video content;
in response to the request, determine whether a video content provider associated with the video content permits display of a menu at a viewer device currently with the video content that is being presented, the menu including selectable options corresponding to musical content items associated with the video content;
in response to the video content provider permitting the display of the menu while the video content is being presented, provide the menu to be displayed concurrently with the video content; and
in response to the video content provider not permitting the display of the menu while the video content is being presented, inhibiting presentation of the menu while the video content is being presented.

9. The server of claim 8, further comprising, in response to the video content provider not permitting the display of the menu while the video content is being presented, providing the menu separately or after presentation of the video content is concluded.

10. The server of claim 8, further comprising, in response to the video content provider not permitting the display of the menu while the video content is being presented, provide a viewer-detectable indication that the request has been received.

11. The server of claim 10, wherein the viewer-detectable indication further indicates that the menu will be provided at a time when the video content is not being presented.

12. The server of claim 8, wherein the processor is further configured to determine information that relates a time when the request is generated to a portion of the video content.

13. The server of claim 12, wherein the processor is further configured to query a database based on the information, wherein, in response to the query, the database identifies one or more musical content items that are associated with at least the portion of the video content.

14. The server of claim 8, wherein the processor is further configured to, in response to the request, query a database for a list of musical content items, each musical content item associated with musical content that is associated with the video content.

15. The server of claim 14, wherein the processor is further configured to receive the list of musical content items from the database and to generate the menu including selectable options associated with one or more musical content items of the list of musical content items.

16. A set top box device comprising:
a display device interface; and
a processor coupled to the display device interface, the processor configured to:
receive a request to purchase playback rights to musical content that is associated with video content being presented at a display coupled to the display interface;
in response to the request, send a query to a server to determine whether a video content provider of the video content permits presentation of a menu associated with the musical content concurrently with the video content;
in response to a first indication from the server that the video content provider permits presentation of the menu concurrently with the video content, present the menu at the display while the video content is being presented at the display; and
in response to receipt of a second indication from the server that the video content provider prohibits presentation of the menu concurrently with the video content, inhibit presentation of the menu until a time when the video content is not being presented.

17. The set top box device of claim 16, wherein the menu includes a plurality of selectable options, each selectable option associated with a corresponding musical content item.

18. The set top box device of claim 17, wherein the selectable options are determined from a database that includes information relating particular musical content with particular video content.

19. The set top box device of claim 17, wherein the menu includes one or more sample trigger selectable options, each sample trigger selectable option associated with a corresponding selectable option of the menu, and wherein the processor is further configured to output a corresponding musical sample in response to selection of a sample trigger selectable option.

20. The set top box device of claim 17, wherein the processor is configured to provide a purchase menu in response to receipt of a selection of a particular selectable option of the plurality of selectable options in the menu, the purchase menu enabling a viewer to purchase the playback rights to particular musical content associated with the particular selectable option that is selected.
